(19) United States
(12) Patent Application Publication
(10) Pub. No.: US 2021/0396381 A1
(43) Pub. Date: Dec. 23, 2021

(54) ELONGATED MODULAR HEATSINK WITH COUPLED LIGHT SOURCE

(71) Applicant: EXPOSURE ILLUMINATION ARCHITECTS, INC., Scottsdale, AZ (US)

(72) Inventor: Daniel S. Spiro, Scottsdale, AZ (US)

(21) Appl. No.: 17/464,417

(22) Filed: Sep. 1, 2021

Related U.S. Application Data
(63) Continuation-in-part of application No. 17/397,508, filed on Aug. 9, 2021.
Application No. 17/397,508 is a continuation-in-part of application No. 16/672,218, filed on Nov. 1, 2019, now Pat. No. 11,085,627.
Application No. 16/672,218 is a continuation-in-part of application No. 16/019,329, filed on Jun. 26, 2018, now Pat. No. 10,502,407.
(60) Provisional application No. 62/674,431, filed on May 21, 2018.

(51) Int. Cl. F21V 29/76; F21K 9/275; F21S 4/28

(52) U.S. Cl. CPC F21V 29/763; F21S 4/28; F21K 9/275

(57) ABSTRACT

An elongated heatsink structure retaining single and/or bi-directional light sources that receive variable power input(s) through at least one endcap coupled to the elongated heatsink structure.

### CROSS-REFERENCE TO RELATED APPLICATIONS

This application is continuation-in-part of co-pending U.S. application Ser. No. 17/397,508, filed Aug. 9, 2021, which is continuation-in-part of U.S. application Ser. No. 16/672,218, filed Nov. 1, 2019, now U.S. Pat. No. 11,085,622, which is continuation-in-part of U.S. application Ser. No. 16/019,329, filed Jun. 26, 2018, now U.S. Pat. No. 10,502,407, which claims benefit of U.S. Provisional Application No. 62/674,431, filed May 21, 2018. The disclosures of each of the above-mentioned applications are hereby incorporated by reference herein in their entirety.

### TECHNICAL FIELD

The present disclosure generally relates to a lighting structure.

### BACKGROUND

Traditional fluorescent lamps have a bulky exterior profile and consume a large amount of energy. Lighting implements, such as fluorescent lamps and others, usually have only rudimentary controls and, as such, consume excessive energy.

### SUMMARY

An elongated heatsink structure of the present disclosure includes a core and unitary fins coupled to the core's exterior surfaces extending outwardly. Between the fins, at least one flat surface is configured to retain at least one light source. The light weight elongated heatsink structure's reduced profile design enables a substantial portion heat generated by a light source to be conveyed directly through the heatsink core to most of the plurality of the heat dissipating fins.

The present elongated heatsink structure is defined by a core with a plurality of unitarily heat dissipating fins coupled to the core's exterior surfaces, at least one flat surface retaining at least one light source, a bore in the core extending the longitudinal length of the elongated heatsink structure, and at least one endcap coupled to at least one end of the elongated heatsink structure. The endcap/s couple/s to lamp holder/s and is/are configured to be detachable. The endcap/s provide at least one of: a mechanical and an electrical connectivity to the elongated heatsink structure.

The elongated heatsink structure is configured to be used in existing and new luminaires. For this reason, at least one endcap connector is configured to detachably couple to a standard industry lamp holder. The endcap connector can be at least one of: G5, G13, slimline single pin and RDC lamp holder connector. The G5 and the G13 bi-pin connectors are the lighting industry's most common lamp connectors. Therefore, the elongated heatsink structure in at least one configuration is coupled to a G13 connector. Luminaire lamp holders configured to receive G5 or other connector styles can be fitted with G13 lamp holders. In addition, new designed lamp holders can be used providing additional mounting and control features.

The elongated heatsink structure's coupled light source receives its power through at least one endcap. The light source's is/are coupled to at least one exterior flat surface of the elongated heatsink structure. Power delivered to at least one light source can be is controlled by at least one of: an onboard and/or a remote processor/controller.

The elongated heatsink structure can have two endcaps, one at each end. Power or power and data can flow to both endcaps or independently of one another to each endcap. Power and/or data connectivity to both endcaps can be from both ends lamp holders or from a single lamp holder. Single end cap can convey power and/or data to the opposing side endcap through the elongated heatsink core through bore. The following articulates several examples for the elongated heatsink structure's light source power or power and data circuitry:

The elongated heatsink structure retains two light sources, one along the top surface and the other along the bottom surface. The light source/s is/are configured to operate independently of one another. The present example may employ two input power circuits—one coupled to one endcap, and the other coupled to the other endcap, wherein the first coupled endcap provides power and/or data to the top retained light source and the second endcap provides power and/or data to the bottom retained light source.

The elongated heatsink structure retains one light source coupled to the elongated heatsink structure bottom. In this configuration, power and/or power and data can be conveyed to a single endcap. This endcap provides both mechanical and electrical connectivity. At the opposite side of the elongated heatsink structure, the other coupled endcap provides mechanical connectivity only.

In another configuration, more than one type of light source is coupled to at least one lamp retaining surface of the elongated heatsink structure. Such light source types can include UV light and a white ambient light source. The two light sources can be controlled through a single endcap, or in another configuration through both endcaps. In each of the two configurations, each of the distinct light sources has a dedicated circuit.

In yet another example the elongated heatsink structure retains two light sources, one along the top surface and the other along the bottom surface. The light source(s) is/are configured to operate jointly and independently of one another. The present example may employ a single or two input power circuits. The single input power circuit conveying power through a single endcap may power both the top and bottom light sources. Using G13 bi-pins, each pin conveys power connectivity to each of the top and bottom coupled light sources. In this configuration the spacing of light sources populating one of the light source may vary from the other light source, while each light source receives the same input power.

The lamp holders' electrical and/or data circuitry at one end connect to the elongated heatsink structure's endcaps. At the other end, the circuitry connects directly or indirectly to at least one of: a power supply, a communication device, a switching device, a processing/controlling device, backup power device, an output device and a sensing device. The communication device can be wired and/or can be wireless.

For example, a luminaire can be assigned a unique address having two sub-addresses. A wireless communication device coupled to the luminaire is communicatively coupled to a remote controller. The communication device receives power from an external source, conveying signal to one sub-address. The signal received is conveyed to a microprocessor. The microprocessor's controller switches on a microswitch/relay flowing power to a light source driver and/or directing the light source driver to modulate the light source output. Another received signal is conveyed to the luminaire's other sub-address, having the same and/or different operational instructions.

The onboard processing/controlling device can be coupled to other sensing and backup power devices that can operate in unison with the remote controller and/or can operate independently. The operation of the luminaire retaining the elongated heatsink/s can be configured to respond to sensed input/s indicating that life and/or property are at risk.

Arrangements within the present disclosure replaces dated fluorescent lamp technology with LED lamp technology. Devices, systems, and methods within the present disclosure can provide the benefit of energy consumption reduction. This energy consumption reduction is due to an efficient heatsink design that can enable rapid absorption and dissipation of heat produced by high output light source having a small profile.

Devices, systems, and methods within the present disclosure can be mostly suited for medium and high mounted luminaire applications. Many of such luminaire applications can have rudimentary controls. As a result, the luminaires consume excessive energy. Devices, systems, and methods within the present disclosure can enable controlling each luminaire light source. The luminaires also can be fitted with a wired or wireless communication device using, for example, meshed Bluetooth or Zigbee communication protocols. Separately, the present innovation can replace fluorescent lamp/s and corresponding ballast/s with the elongated heatsink structure/s coupled to LED light source/s with corresponding driver/s.

### BRIEF DESCRIPTION OF THE DRAWINGS

The detailed description particularly refers to the following figures, in which:

FIGS. 1A, 1B, and 1C show typical lighting industry endcap connectors;

FIG. 2 shows a power/data circuitry diagram of the elongated heatsink coupled to top and bottom light sources and disposed inside a luminaire;

FIG. 3 shows a power/data circuitry diagram for a bottom mounted light source receiving power/data from a single endcap;

FIG. 4 shows a power/data circuitry diagram for a bottom mounted light source having different type light sources receiving power/data from two endcaps; and

FIG. 5 shows a power/data circuitry diagram with top and bottom light sources wherein the top and bottom light sources have different spacing.

### DETAILED DESCRIPTION

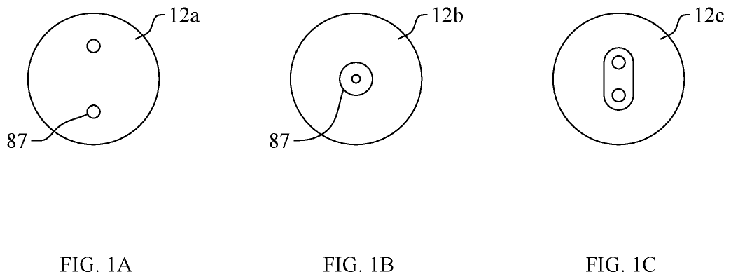

FIGS. 1A, 1B and 1C illustrate exemplary endcap electromechanical connectors 12a, 12b, 12c, respectively, used with fluorescent lighting devices. FIG. 1A shows a bi-pin connector 12a configuration, known as either G5, or G13, where G historically referred to ‘glass’ material used for the original bulbs and numeral after G refers to a pin spread, or pitch, of pins 87 in millimeters (mm). The G5 endcap connector is associated with the T5 fluorescent lamp and the G13 endcap connector is associated with the T8, T10, and T12 fluorescent lamps. The designation T stands for the lamp shape being ‘tubular’ and the numbers 5, 8, and 12 stand for the lamp's diameter divided by 8. Following this designation, the T5 lamp diameter is ⅝″, the T8 lamp diameter is 1.0″, and the T12 lamp diameter is 1.5″.

Among the endcaps' electromechanical connectors 12a, 12b, and 12c, shown in FIGS. 1A, 1B and 1C, the bi-pin endcap connector 12a typically carries the lowest lamp wattage. Nonetheless, this endcap connector 12a is the most widely used endcap connector.

FIG. 1B shows a single pin connector 12b configuration known as Fa8. The Fa8 endcap connector is commonly used with T8, T10 and T12 lamps. The connector 12b wattage conveyed to the lamp ranges from normal to high output, such as with luminous flux between 1 and 12000 lumen. This connector 12b is coupled to F48 and F96 lamps. The F stands for ‘fluorescent’ and the number following “F” stands for the length of the tube measured in inches.

FIG. 1C shows a double recessed connector 12c configuration, known also as Recessed Direct Contact (RDC). The RDC connector 12c is typically used with lamps requiring high and very high power output. The RDC connector 12c is used with T10 and T12 lamps with length extending up to 96″ (8 feet).

The light intensity output per linear foot of the present disclosure can exceed the light intensity output generated by each of the above-referenced fluorescent lamps, such as T8, T10, T12, F48, and F96, employing the G5, G13, Fa8, and the RDC endcap connectors.

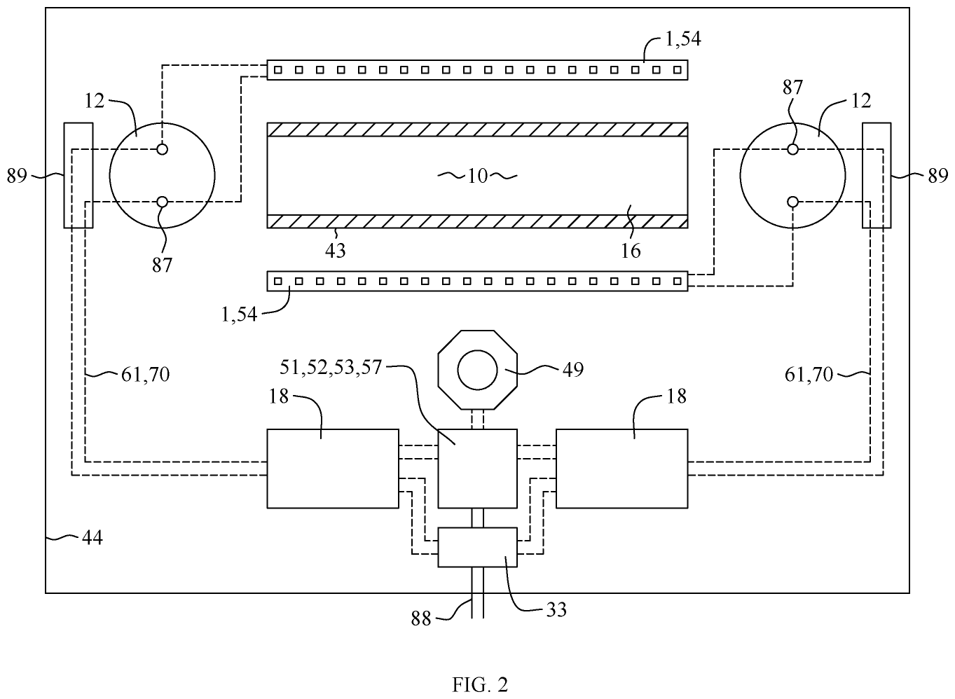

FIG. 2 shows a power/data circuitry diagram of an elongated heatsink structure 10 coupled to top and bottom light sources 1, 54 and disposed inside a luminaire or luminaire housing 44. House power 88 in this circuitry configuration is distributed through an enclosure/junction box 33 to two drivers 18 and at least one of: a processor/controller 51, a power management module 52, a memory storage device 53, and a communication device 57. The processor/controller 51 can be coupled to at least one sensing device 49. In an example configuration, the processor/controller 51 can be coupled to an occupancy sensor. Low voltage conductors shown between the processor/controller 51 and the sensing device 49 provide power to and carry signal from the sensing device. The low voltage conductors shown between the processor/controller 51 and the drivers 18 transmit control signal to the drivers 18. The control signal can include on/off and/or dim command. Conductors originating from each of the two drivers 18 couple to lamp holders 89 at opposite ends of the luminaire 44. The elongated heatsink structure 10 with the endcaps 12 coupled thereto at both ends, detachably couples to the lamp holders 89 engaging the endcaps' bi-pins 87 inside retaining grooves in the lamp holders 89; where element 12 illustrates an example endcap, such as, but not limited to, the endcap configurations 12a, 12b, and 12c described in reference to FIGS. 1A, 1B, and 1C. In the present configuration, the lamp holders 89 provide both mechanical and electrical connectivity. For illustration purposes, the example configuration of FIG. 2 shows one driver 18 providing power to one of the light sources 1, 54, e.g., the light source coupled to the top of the elongated heatsink structure 10, and another driver 18 providing power to a different one of the light sources 1, 54, e.g., the light source coupled to the bottom of the elongated heatsink structure 10. In other examples, one driver 18 can provide power to a plurality of light sources 1, 54 coupled to a plurality of elongated heatsink structures 10 disposed inside the luminaire 44. Further, the light sources 1, 54 can be locally controlled and/or be communicatively coupled to a remote controller and/or the neighboring devices.

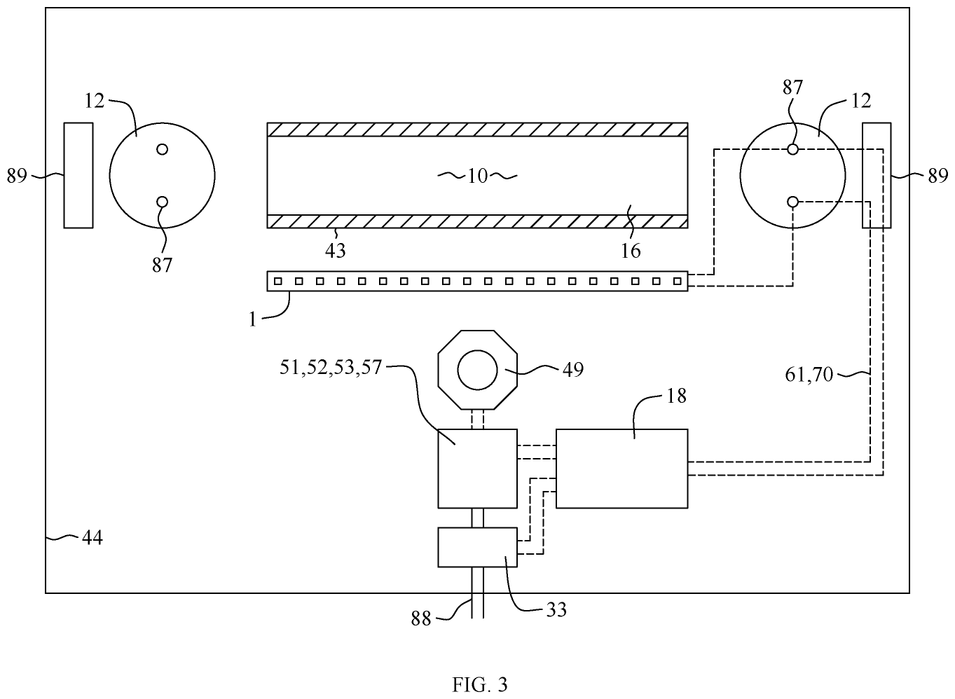

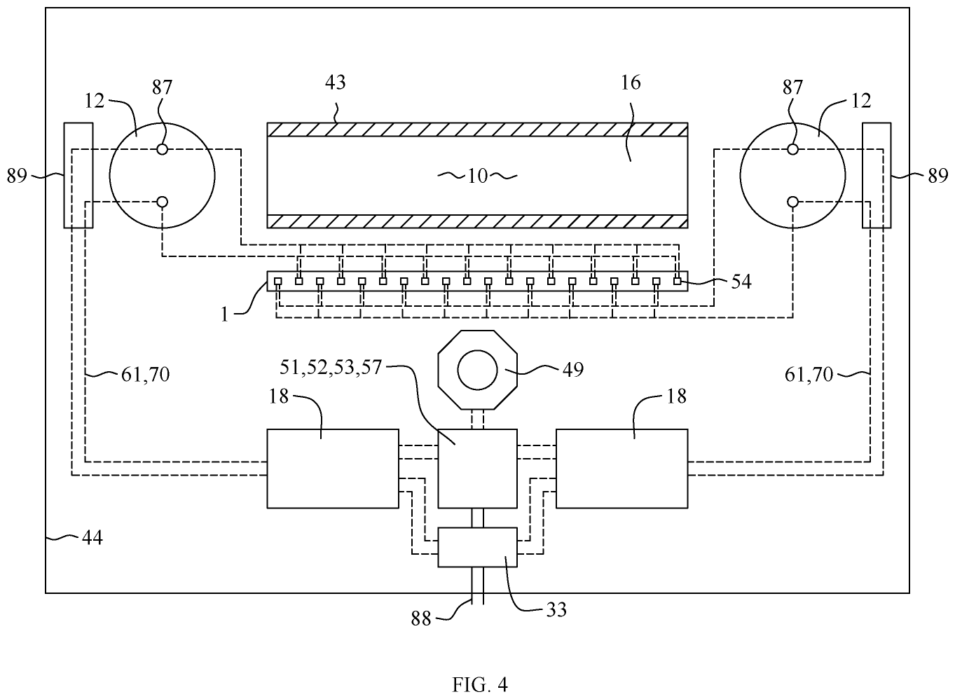

FIG. 3 shows a power/data circuitry diagram of the elongated heatsink structure 10 coupled to a bottom light source 1, 54 and disposed inside the luminaire 44. House power 88 in the circuitry configuration of FIG. 3 is distributed through an enclosure/junction box 33 to a single driver 18 and at least one of: a processor/controller 51, a power management module 52, a memory storage device 53, and a communication device 57. The processor/controller 51 can be coupled to at least one sensing device 49. In an example configuration the processor/controller 51 is coupled to an occupancy sensor. Low voltage conductors shown between the processor/controller 51 and the sensing device 49 provide power to and carry signal from the sensing device 49. Low voltage conductors shown between the processor/controller 51 and the driver 18 transmit control signal(s) to the driver 18. The control signal(s) can include on/off and/or dim command. Conductors originating from the driver 18 couple to lamp holders 89 at one end of the luminaire 44. This lamp holder 89 conveys power and/or data to the elongated heatsink structure 10 light source 1, also providing a mechanical connectivity for the same elongated heatsink structure 10. The lamp holder 89 disposed at the opposite end of the luminaire 44 provides mechanical connectivity for the elongated heatsink structure 10; and in some embodiments, may provide only mechanical connectivity. The pins 87 of the endcap 12 detachably couple to the lamp holders 89 by mechanically engaging retaining grooves in the lamp holders 89. For illustration purposes, the configuration of FIG. 4 shows a single driver 18 providing power and/or data to a single light source 1 coupled to the bottom surface of the elongated heatsink structure 10. Actually, the driver 18 can provide power to a plurality of light sources 1 coupled to a plurality of elongated heatsinks structures 10 disposed inside the luminaire 44. Further, the light sources 1 can be locally controlled and/or be communicatively coupled to a remote controller and/or the neighboring devices.

FIG. 4 shows a power/data circuitry diagram of the elongated heatsink structure 10 coupled to the bottom light source 1, 54 and disposed inside the luminaire 44. House power 88 in the circuitry configuration of FIG. 4 is distributed through an enclosure/junction box to two drivers 18 and at least one of: a processor/controller 51, a power management module 52, a memory storage device 53 with code 56 (such as written instructions), and a communication device 57. The processor/controller 51 can be coupled to at least one sensing device 49. In an example configuration the processor/controller 51 is coupled to an occupancy sensor. Low voltage conductors shown between the processor/controller 51 and the sensing device 49 provide power to and carry signal from the sensing device 49. Low voltage conductors shown between the processor/controller 51 and the drivers 18 transmit control signal(s) to the drivers 18. The control signal(s) can include on/off and/or dim command. Conductors originating from each of the two drivers 18 couple to the lamp holders 89 at opposite ends of the luminaire 44. The elongated heatsink structure 10, with the endcaps 12 coupled thereto at both ends, detachably couples to the lamp holders 89 engaging the pins 87 of the endcap 12 inside retaining grooves in the lamp holders 89. In the present configuration, the lamp holders 89 provide both mechanical and electrical connectivity. For illustration purposes, the configuration of FIG. 4 shows a single driver 18 providing power and/or data to a distinct light source 1 coupled to the bottom surface of the elongated heatsink structure 10 and another driver 18 providing power and/or data to a different light source 1 also coupled to the bottom surface of the elongated heatsink structure 10. The at least two light sources can include different parameters of at least one of: color temperature, color rendering index (CRI) and lumen output from those of one another. In an example, a driver 18 can provide power to a plurality of light sources 1 coupled to a plurality of elongated heatsink structures 10 disposed inside the luminaire 44. For example, the first driver provides power to “white” ambient light source wherein the other driver provides power to the UV bacteria/virus disabling light source. The control of the drivers is by the local processor/controller employing sensing device/s and is communicatively coupled to remote controller/s. Further, the light sources 1 can be locally controlled at least in part by neighboring devices.

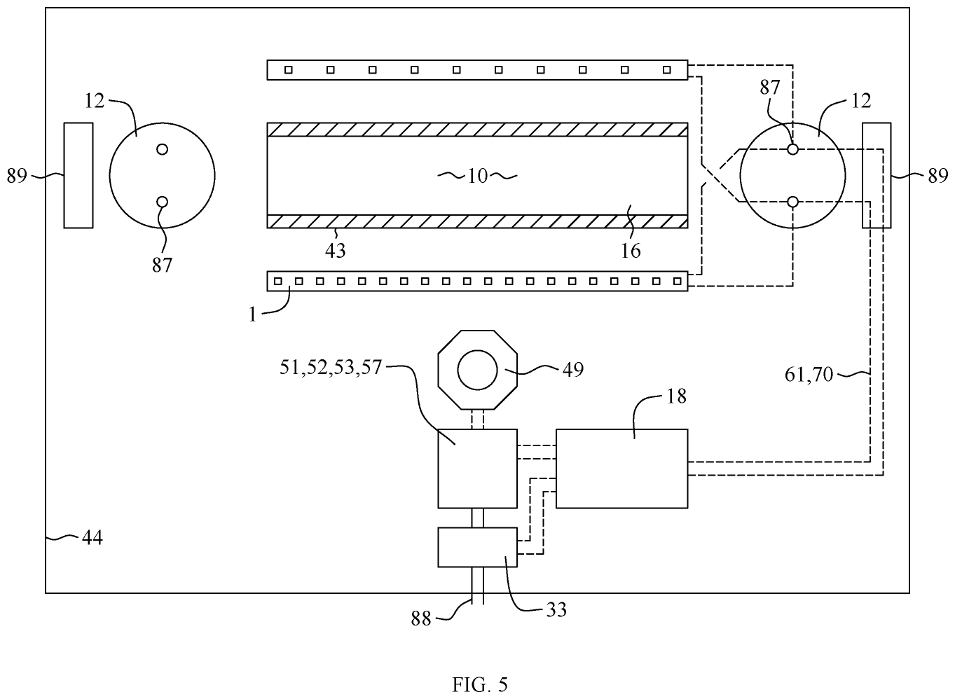

FIG. 5 shows a power/data circuitry diagram of the elongated heatsink structure 10 coupled to the top and bottom light sources 1, 54 and disposed inside the luminaire 44. House power 88 in the circuitry of FIG. 5 configuration is distributed through an enclosure/junction box to a single driver 18 and at least one of: a processor/controller 51, a power management module 52, a memory storage device 53, and a communication device 57. The processor/controller 51 can be coupled to at least one sensing device 49. In an example configuration, the processor/controller 51 is coupled to an occupancy sensor. Low voltage conductors shown between the processor/controller 51 and the sensing device 49 provide power to and carry signal from the sensing device. Low voltage conductors shown between the processor/controller 51 and the driver 18 transmit signal to the driver 18. The signal can include on/off and/or dim command. Conductors originating from the driver 18 couple to the lamp holders 89 at one end of the luminaire 44. The lamp holder 89 conveys power and/or data to the elongated heatsink structure 10 light source 1 also providing a mechanical connectivity for the same elongated heatsink structure 10. The lamp holder 89 disposed at the opposite end of the luminaire 44 provides mechanical connectivity for the elongated heatsink structure 10; and in some embodiments may only provide mechanical connectivity. The pins 87 of the endcap 12 detachably couple to the lamp holders 89 by mechanically engaging retaining grooves in the lamp holders 89. For illustration purposes, the configuration of FIG. 5 shows a single driver 18 providing power and/or data to top and bottom light sources 1 coupled to the elongated heatsink structure 10. In this example, power and/or data is conveyed by the conductor from the pins 87 of the endcap 12 to the top and bottom coupled light sources 1, 54. As shown in FIG. 5, the top LED light sources 1, 54 are spaced farther apart than the bottom coupled LED light sources 1, 54. In this example of differently spaced LED units, the driver 18 provides equal power to each of the top and bottom coupled light sources 1, 54; however, the bottom coupled light source 1, 54 is configured to generate higher light output. While this example depicts a single elongated heatsink structure 10 with two coupled light sources 1, 54, the driver 18 can provide power to a plurality of light sources 1 coupled to a plurality of elongated heatsinks structures 10 disposed inside the luminaire 44. Further, the light sources 1 can be locally controlled and/or be communicatively coupled to a remote controller and/or the neighboring devices.

While the concepts of the present disclosure are susceptible to various modifications and alternative forms, specific exemplary embodiments are been shown by way of example in the drawings and will be described. It should be understood, however, that there is no intent to limit the concepts of the present disclosure to the particular forms disclosed; on the contrary, the intention is to cover all modifications, equivalents, and alternatives falling within the spirit and scope of the invention as defined by the appended claims.

References in the specification to “one embodiment,” “an embodiment,” “an illustrative embodiment,” etc., indicate that the described embodiment may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); (A and C); or (A, B, and C). Similarly, items listed in the form of “at least one of A, B, or C” can mean (A); (B); (C): (A and B); (B and C); (A and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

There are a plurality of advantages of the present disclosure arising from the various features of the method, apparatus, and system described herein. It will be noted that alternative embodiments of the method, apparatus, and system of the present disclosure may not include all of the features described yet still benefit from at least some of the advantages of such features. Those of ordinary skill in the art may readily devise their own implementations of the method, apparatus, and system that incorporate one or more of the features of the present invention and fall within the spirit and scope of the present disclosure as defined by the appended claims.

Element List

1 Light source
3 Rack
4 Ceiling
5 Floor
10 Heat sink
11 Light source modules
12 Endcap receptacle
13 Fin/s
14 Mechanical key
15 Conductor(s)
16 Bore
18 Driver and/or another device/s
33 J box
34 J box cover
35 Release button/latch
36 Conduit
37 Power or power and data receptacle
39 Knockout opening
40 Cable or chain hanging opening
41 Anchoring protrusion
43 Heatsink core
44 Luminaire
47 Power or power and data entry
49 Occupancy sensor
51 Processor/controller
52 Power management module/power supply
53 Memory storage device
54 UV/GUV light source
55 Camera
56 Code
57 Communication device
58 Micro switch
59 Indicator light
60 Sound emitting/receiving device
61 Power and/or data conductor
62 Electronic device
63 Wireless device
64 Plate joiner
65 Sensing device
66 Saddle joiner
67 Hanger
68 Dip switch
70 Local power and/or power and data conductor
71 Mechanical fastener
72 Slotted bore
73 Keyed joiner opening
74 Mechanical protrusion/s
75 Device receptacle
76 Device power and data port
77 Receptacle recess
78 Saddle wall, vertical wall
79 Saddle device mounting surface
80 Joiner top surface
81 Joiner bottom surface
82 Plate top surface
83 Plate bottom surface
84 Dip switch opening
85 Through line power and/or data
86 Local power and/or data
87 Pin
88 House power
89 Lamp holder

1. An elongated heatsink structure with a solid or substantially solid core, the elongated heatsink structure comprising:
a plurality of light sources, a plurality of heat dissipating fins, and at least one endcap,
wherein each of the plurality of light sources is coupled to at least one exterior surface of the elongated heatsink structure,
wherein the plurality of heat dissipating fins is unitarily coupled to the core of the heatsink,
wherein a portion of heat generated by the at least one of the plurality of light sources is conveyed through the core of the heatsink structure directly to most of the plurality of the heat dissipating fins,
wherein each at least one endcap couples to each end of the elongated heatsink structure,
wherein the at least one endcap provides at least one of: electrical and mechanical connectivity to the elongated heatsink structure, and
wherein the at least one end cap is configured as at least one of: a single circuit endcap and a dual circuit end cap, and is configured to convey power and/or data to at least one of the plurality of light sources.

2. The elongated heatsink structure of claim 1, wherein intensity output of at least one of the plurality of light sources exceeds intensity output of another one of the plurality of light sources.

3. The elongated heatsink of claim 1, wherein at least one of the plurality of light sources can be independently controlled for at least one of on/off, dimming, and/or color operation.

4. The elongated heatsink structure of claim 1, wherein at least one of: a color temperature and/or a color rendering index (CRI) of one of the plurality of light sources is different from that of another one of the plurality of light sources.

5. The elongated heatsink structure of claim 1, wherein at least one of the plurality of light sources emits photonic energy having wavelength within the ultraviolet spectrum.

6. The elongated heatsink structure of claim 5, further comprising at least one processor coupled to at least one of: a communication device, a sensing device, a power storage device, and an output device.

7. The elongated heatsink structure of claim 6, wherein the at least one processor is coupled to the communication device and at least one of: the sensing device, the power storage device, and the output device, such that the at least one of the sending device, the power storage device, and the output device is addressable by the communication device for at least one of power, data, or a combination of both.

8. An elongated heatsink structure with a solid or substantially solid core comprising:
at least one light source, heat dissipating fins and at least one endcap,
wherein at least one light source is coupled to an exterior surface of the elongated heatsink structure,
wherein a plurality of heat dissipating fins is unitarily coupled to the core of the heatsink exterior,
wherein a portion of the heat generated by a light source is conveyed through the heatsink core directly to most of the plurality of the heat dissipating fins,
wherein endcaps are coupled to the elongated heatsink structure at both ends,
wherein each endcaps provides at least one of: electrical and mechanical connectivity to the elongated heatsink structure that retains the at least one light source, and
wherein at least one of the endcaps is configured to convey power and/or data to at least two of the at least one light sources disposed at opposing sides of the elongated heatsink structure.

9. The elongated heatsink structure of claim 8 wherein at least one light source output exceeds another coupled light source.

10. The elongated heatsink of claim 8 wherein at least one light source can be independently controlled for at least one of on/off, dimming, and/or color operation.

11. The elongated heatsink structure of claim 8, wherein at least one of: the light color temperature and/or the color rendering index (CRI) of one of the at least one light source is different from that of another of the at least one light source.

12. The elongated heatsink structure of claim 8, wherein at least one of the at least one light source emits photonic energy in the bandwidth of ultraviolet.

13. The elongated heatsink structure of claim 8, wherein at least one processor is coupled to at least one of: a communication device, a sensing device, a power storage device, and an output device, as at least one coupled device.

14. The elongated heatsink structure of claim 8, wherein the at least one coupled device is addressable by the communication device.

15. An elongated heatsink structure with a solid or substantially solid core comprising:
at least one light source, heat dissipating fins, and at least one endcap,
wherein at least one light source is coupled to at least one exterior surface of the elongated heatsink structure,
wherein a plurality of heat dissipating fins is unitarily coupled to the core of the heatsink exterior,
wherein a portion of the heat generated by the at least one light source is conveyed through the heatsink core directly to most of the plurality of the heat dissipating fins,
wherein endcaps are coupled to the elongated heatsink structure at both ends,
wherein the endcaps provide at least one of; electrical and mechanical connectivity to the elongated heatsink that retains the at least one light source, and
wherein each of the two endcaps conveys power and/or data to different light sources of the at least one light source that are disposed on the same retaining surface of the elongated heatsink structure.

16. The elongated heatsink of claim 15 wherein the at least one light source can be independently controlled for at least one of on/off, dimming, and/or color operation.

17. The elongated heatsink structure of claim 15, wherein at least one of: the light color temperature and/or the color rendering index (CRI) of one of the at least one light source is different from that of another of the at least one light source.

18. The elongated heatsink structure of claim 15, wherein at least one of the at least one light source emits photonic energy in the bandwidth of ultraviolet.

19. The elongated heatsink structure of claim 15, wherein at least one processor is coupled to at least one of: a communication device, a sensing device, a power storage device, and an output device, as at least one coupled device.

20. The elongated heatsink structure of claim 15, wherein the at least one coupled device is addressable by the communication device for at least one of power, data, or a combination of both.
